(19) United States
(12) Patent Application Publication
(10) Pub. No.: US 2015/0300548 A1
(43) Pub. Date: Oct. 22, 2015

(54) ADJUSTABLE WATER MAIN TAP APPARATUS

(71) Applicant: Kevin Korte, Breese, IL (US)

(72) Inventors: Kevin Korte, Breese, IL (US); Kenneth J. Luitjohan, Albers, IL (US)

(21) Appl. No.: 14/686,211

(22) Filed: Apr. 14, 2015

Related U.S. Application Data
(60) Provisional application No. 61/981,444, filed on Apr. 18, 2014.

(51) Int. Cl. F16L 41/04; F16L 47/34

(52) U.S. Cl. CPC F16L 41/04; F16L 47/34

(57) ABSTRACT

A water main tapping apparatus comprising a sleeve for attachment around the water main, a branch a branch pipe on one side of the sleeve, a tapping valve rotatably connected to the branch pipe; and sealing apparatus to seal the tapping valve to the branch pipe.

### CROSS REFERENCE TO RELATED APPLICATIONS

This application claims the benefit of U.S. provisional patent application Ser. No. 61/981,444 filed Apr. 18, 2014 which is incorporated herein by reference.

### BACKGROUND

The present disclosure relates to a water main tapping apparatus and more particularly to an adjustable water main tapping apparatus that allows vertical positioning of a valve connector.

In general, a tapping sleeve is positioned around a main water line for connecting the main water line to the new branch. A tapping valve is frequently connected between the tapping sleeve and the new branch for regulating water flow in the branch. The main water line is then tapped in a sealed manner allowing water to flow into the branch via the tapping sleeve and the tapping valve combination.

The tapping sleeve is typically comprised of steel and is attached to the tapping valve by means of a flange welded to the tapping sleeve's branch pipe and connected to the tapping valve by nut and bolt combinations. However, the tapping valves are attached to the tapping sleeve with by fixed means, usually bolds or other fixed means. In some cases, a stainless steel flange is incorporated in the tapping sleeve for connection to the flanged joint of the tapping valve. In any event, the orientation of the tapping valve is fixed relative to the tapping sleeve and hence fixed relative the overlying surface.

In this arrangement, positioning the tapping sleeve on the water main is done with some difficulty, particularly where access is limited as in excavated underground locations. In addition, the orientation of the tapping sleeve and tapping valve combination dictated by the orientation of the water main. This can result in a non-vertical orientation of the attached tapping valve when the main water line is not level, or horizontal. Because the tapping valve is typically buried at a depth of at least six feet, manipulating a non-vertical tapping valve to control water flow from the surface of the ground down to the tapping valve is very difficult, and frequently impossible.

It would be advantageous to provide a tapping sleeve and adjustable tapping valve that allows vertical orientation of the tapping valve after installation of the combination on a water main.

### SUMMARY OF THE DISCLOSURE

A water main tap having a tapping sleeve with a branch pipe, a tapping valve rotatably mounted on the branch pipe, sealed with a circular gasket and held in position by a split clamp.

The tapping sleeve is positioned on the water main; the tapping valve is rotated about the branch pipe until the valve is orientated vertical to the surface. The split clamp is tightened to secure the tapping valve in place on the end of the branch pipe.

### BRIEF DESCRIPTION OF THE DRAWINGS

FIG. 1 is an exploded perspective view of the adjustable water main tap; and

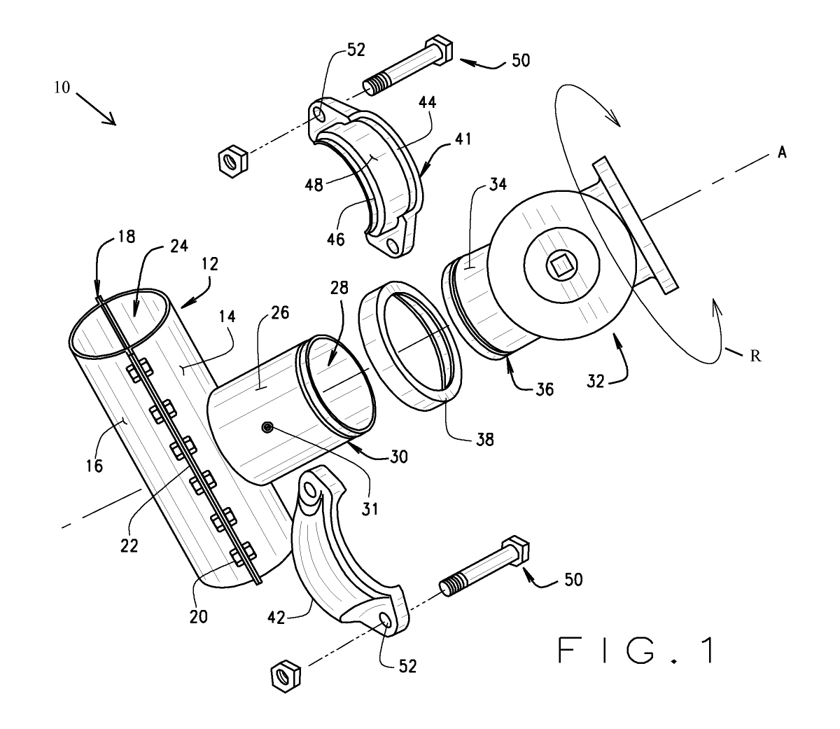

FIG. 2 is a partial cross-sectional view thereof.

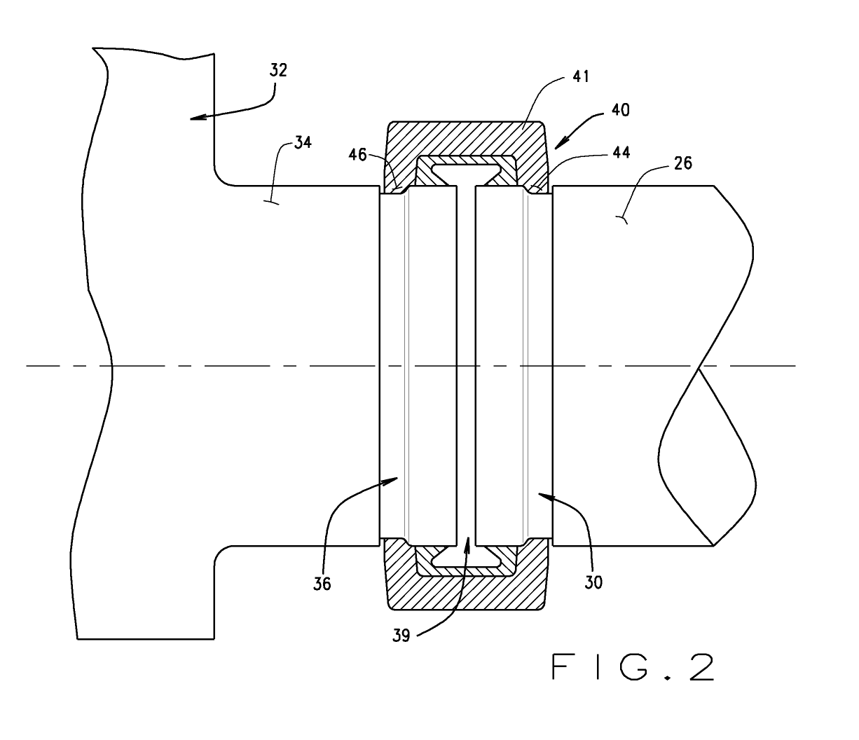

### DETAILED DESCRIPTION

The following detailed description illustrates the tap assembly 10 by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the tap assembly 10 is not limited in its application to the details of construction and the arrangements of components or the dimensions set forth in the following description or illustrated in the drawings. The tap assembly 10 is capable of other embodiments and of being practiced or being carried out in various ways. Also, it is to be understood that the phraseology and terminology used herein is for the purpose of description and should not be regarded as limiting.

A sleeve 12 which, as shown, comprises a first half 14 and a second half 16 spit along seam 18. In use the two halves are positioned around a water main pipe and secured together by a plurality of bolts 20 extending through opposed flanges 22, or any other appropriate securing means. When the two halves are secured together the define bore 24. The diameter of bore 24 is appropriate to allow sleeve 12 to surround a water main pipe and be tightened into a water tight seal with bolts 20 or other securing means. For example, the two halves could be held in position around a pipe with clamps or any other appropriate means.

There is a branch pipe 26 on first half 14. Branch pipe 26 defines bore 28, which is in fluid communication with bore 24. There is a clamp groove 30 around the open end of branch pipe 26. Branch pipe 26 also includes test plug 31 to allow access for testing. A tapping valve 32 is positioned at the open end of branch pipe 26. Tapping valve is conventional in its construction and operation. Tapping valve 32 includes a cylindrical extension 34 which defines an internal bore (not seen) that, when assembled, is in fluid communication with bore 28 of branch pipe 26. There is a clamp groove 36 around the open end of cylindrical extension 34.

There is a rubber gasket 38 or O-ring style seal sized and configured to surround the abutted open ends of branch pipe 26 and cylindrical extension 34 at their juncture 39. A split clamp 40 comprising a first half 41 and a complementary second half 42 surrounds gasket 38 and the abutted ends at juncture 39 to seal the tapping valve to the branch pipe. Each half of clamp 40 has a generally C-shaped cross-sectional configuration with a first side 44 and second side 46 defining a center channel 48. First side 44 seats in clamp groove 30 and second side 46 seats in clamp groove 36 with gasket 38 tightly nested in channel 48. The two halves of clamp 40 are secured together by bolt and nut assemblies 50 through holes 52 securing tapping valve 32 to branch pipe 26 with a water-tight seal. It will be understood that any type of clamp that accomplishes the intended function will suffice.

Tap assembly 10, particularly sleeve 12, can be installed on a water main in a conventional manner. In other words, the installer excavates through the surface of the ground under which the water main is buried, if necessary, to expose a section of water main to be tapped. Sleeve 12 is positioned around the exposed water main and tightened in place with bolts 20. Tapping valve 32 is secured to branch pipe 26 with seal 38 and clamp 40, either before or after the sleeve 12 is secured to the water main. It will be understood tapping valve 32 and branch pipe 26 define rotational axis A. Depending upon the angle of the water main, or the surrounding terrain, prior to tightening clamp 40, the installer determines the angular orientation required for tapping valve 32 such that it is in vertical alignment relative to the surrounding surface. Tapping valve 32 can be rotated around rotational axis A, as shown by arrow R, until it is orientated vertical to the surface (or any other desired orientation relative to the surroundings). Since there is rotational orientation the positions of the tapping valve relative to the sleeve and/or surroundings are substantially limitless. Once tapping valve 32 is in the desired and most useful orientation, clamp 40 is tightened. The water main is tapped or drilled into through the apparatus as known to the art, and a water line for service to an adjacent structure is attached to, and extends upwards from, the tapping valve. Because tapping valve 32 can be rotated this water line can extend up vertically despite the relative position of the water main and tapping sleeve.

1. A water main tapping apparatus comprising:
a sleeve defining a bore for positioning around the water main;
a branch pipe on one side of the sleeve in fluid communication with the sleeve bore;
a tapping valve rotatably connected to the branch pipe; and
sealing apparatus to seal the tapping valve to the branch pipe.

2. The water main tapping assembly of claim 1 wherein the sleeve comprises a first half and a second half.

3. The water main tapping assembly of claim 1 wherein the sealing apparatus comprises a seal and a clamp.

4. The water main tapping apparatus of claim 2 wherein the branch pipe is positioned on one of the first or second sleeve halves and is in fluid communication with the sleeve.

5. The water main tapping apparatus of claim 1 wherein the branch pipe and tapping valve define a rotational axis and the tapping valve is rotatable about the axis.

6. The water main tapping apparatus of claim 1 wherein the tapping valve is removably connected to the branch pipe.

7. The water main tapping apparatus of claim 1 wherein the seal is a circular gasket.

8. A water main tapping apparatus comprising:
a sleeve comprising a first half and a second half, said first and second halves defining a longitudinal bore dimensioned to fit around a water main;
a branch pipe on one side of the sleeve in fluid communication with the sleeve bore;
a tapping valve rotatably connected to the branch pipe; and
removable sealing apparatus to seal the tapping valve to the branch pipe comprising a gasket and a clamp.

9. The water main tapping apparatus of claim 8 wherein the branch pipe is positioned on one of the first or second sleeve halves and is in fluid communication with the sleeve.

10. The water main tapping apparatus of claim 8 wherein the clamp comprises a first clamp section and a complementary second clamp section.

11. The water main tapping apparatus of claim 8 wherein the tapping valve is removably connected to the branch pipe.

12. A method of tapping into a water main comprising the steps of:
exposing a section of buried water main by excavating through the surface of the ground under which the water main is buried;
placing a sleeve of a tapping apparatus around the water main, the tapping apparatus comprising the sleeve defining a bore dimensioned to accommodate the water main, a branch pipe in fluid communication with the sleeve, and a tapping valve rotatably installed on the branch pipe; and seal apparatus between the tapping valve and the branch pipe;
securing the sleeve around the water main;
rotating the tapping valve around the branch pipe until the tapping valve is orientated in a desired orientation relative to its surroundings;
tightening the seal apparatus to secure the tapping valve in the desired orientation;
tapping into the water main through the tapping apparatus.

13. The method of claim 12 in which the desired orientation of the tapping valve is such that a water line attached to the tapping valve extends vertically from the tapping valve relative to the surface of the ground.

14. The method of claim 12 wherein a step of installing the tapping valve on the branch pipe is performed before the sleeve is placed around the water main.

15. The method of claim 12 wherein a step of installing the tapping valve on the branch pipe is performed after the sleeve is placed around the water main.
